(19) United States
(12) Patent Application Publication
(10) Pub. No.: US 2017/0156160 A1
(43) Pub. Date: Jun. 1, 2017

(54) SPATIAL MULTIPLE ACCESS UPLINK FOR WIRELESS LOCAL AREA NETWORKS

(71) Applicant: Intel Corporation, Santa Clara, CA (US)

(72) Inventors: Ehsan Aryafar, San Jose, CA (US); Roya Doostnejad, Los Altos, CA (US); Shilpa Talwar, Cupertino, CA (US)

(21) Appl. No.: 15/310,237

(22) PCT Filed: Jun. 11, 2014
(86) PCT No.: PCT/US2014/041858

§ 371 Date: Nov. 10, 2016

(51) Int. Cl. H04W 74/08; H04W 74/00; H04B 7/0452

(52) U.S. Cl. CPC H04W 74/08; H04B 7/0452; H04W 74/006; H04W 84/12

(57) ABSTRACT

A Spatial Multiple Access Uplink for Wireless LANs is generally described herein. A novel FD-MiMAC, protocol leverages full duplex functionality at the Access Point, can be incrementally deployed with current 802.11 Access Point and client devices, can be easily implemented by client devices in a distributed and contention based manner, and pairs users in uplink MU-MIMO to enhance system performance. A method for spatial multiple access uplink in a wireless local area network comprises announcing, by an Access Point (AP), its available remaining antenna capability, receiving, by the AP, a packet header frame transmitted by a winning client uplink contender, allocating, by the AP, uplink resources for the winning client uplink contender and immediately announcing its remaining antenna capability, and transmitting, by the AP, at the end of a winning client's transmission burst, an Acknowledge-to-All frame, whereby other clients may simultaneously restart contention for transmission of next frames.

### TECHNICAL FIELD

Examples generally relate to wireless communications. One or more examples relate to multiple-user (MU) multiple-input-multiple-output (MIMO) uplink protocols for wireless local area networks (LANs).

### BACKGROUND

Multi-User MIMO systems allow multiple clients to transmit on an uplink channel concurrently, thereby fully utilizing the receive antenna(s) of an Access Point (AP). MU-MIMO systems in cellular networks have a central controller, which can precisely measure the wireless channels for tightly controlling and synchronizing mobile devices communicating with base stations. Wireless LANs may also benefit from full duplex MIMO communications, but do not currently enjoy the advantages of an efficient uplink, i.e an equivalent reverse link channel for communicating from a client device to an AP, hampering the user's experience.

There is therefore a need for a system that enables efficient and reliable spatial multiple access in a distributed and asynchronous environment such as wireless LAN.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a network diagram illustrating an exemplary network environment suitable for Spatial Multiple Access Uplink for Wireless LANs, according to some example embodiments;

FIG. 2 compares exemplary conventional single user MIMO operations having low gain due to interference between clients to a full duplex operation;

FIG. 3 illustrates an exemplary Spatial Multiple Access Uplink protocol for wireless LANs, leveraging full duplex functionality;

FIG. 4 a high level overview flow chart illustrating Spatial Multiple Access Uplink for Wireless LANs, according to some example embodiments;

FIG. 5 shows a functional diagram of an exemplary communication station in accordance with some embodiments; and

FIG. 6 shows a block diagram of an example of a machine upon which any of one or more techniques (e.g., methods) discussed herein may be performed.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims

The word “exemplary” is used herein to mean “serving as an example, instance, or illustration.” Any embodiment described herein as “exemplary” is not necessarily to be construed as preferred or advantageous over other embodiments.

The terms “communication station”, “station”, “handheld device”, “mobile device”, “wireless device” and “User Equipment” (UE) as used herein refers to a wireless communication device such as a cellular telephone, smartphone, tablet, netbook, wireless terminal, laptop computer, a femtocell, High Data Rate (HDR) subscriber station, access point, access terminal, or other personal communication system (PCS) device. The device may be either mobile or stationary.

The term “access point” as used herein may be a fixed station. An access point may also be referred to as an access node, a base station or some other similar terminology known in the art. An access terminal may also be called a mobile station, a user equipment (UE), a wireless communication device or some other similar terminology known in the art.

Recently proposed techniques to enable uplink multi-user MIMO in wireless LANs have been based on inefficient polling schemes whereby an AP selects and polls a group of clients for uplink MU-MIMO transmission in a centralized manner. These polling schemes enable uplink MU-MIMO by introducing additional overhead such that an AP can obtain information on the buffered traffic of different clients.

One proposed system for supporting spatial multiple access in wireless LANs to increase network capacity has introduced a contention based and distributed Media Access Control (MAC) protocol for uplink MU-MIMO operations that infers a user's remaining antenna capability (i.e. remaining antenna capability) at the access point by counting the number of overheard preambles and decoding the MAC header of the first uplink client to confirm that the destination of the uplink packet is the AP. However, in practice MAC header transmission rate is optimized for the access point only and thus, clients associated with an access point may not be able to decode a MAC header of another client. Further, this scheme supports only one uplink stream per user, whereas many of the current client devices have multiple antennas and therefore require multiple uplink streams.

In traditional single user communication schemes, one user is served at a time with a mechanism such as time division multiple access (TDMA). However, the throughput of these systems is limited by the minimum number of antennas at the access point (AP) and user's device receiver. Typically, an access point can accommodate a large number of antennas, whereas a user equipment would have a small number of antennas. As a result, the benefits of MIMO in a single user communication scheme are constrained by the number of user antennas.

MIMO offers the potential to achieve high throughput in point-to-point wireless links. Recently, there has been a growing need to fully realize the benefits of MIMO in wireless LAN multi-user scenarios. In a multi-user MIMO LAN system, the AP is equipped with several antennas and communicates simultaneously with several users, each also having one or more antennas.

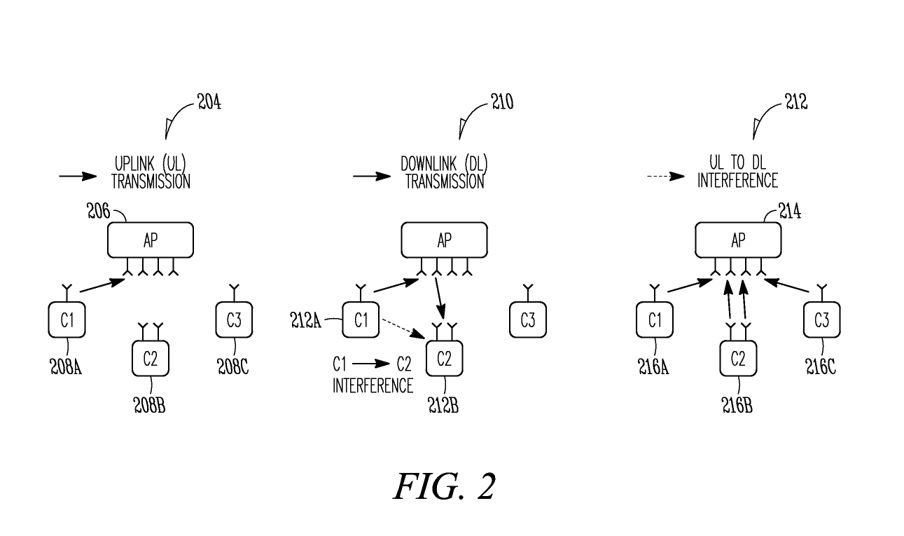

Information theory dictates that multiple clients may form a virtual MIMO system, in which, user equipments (clients) transmit simultaneously. In this MIMO system network, the AP may still decode all received frames correctly as long as the number of concurrent frames is less than the number of antennas at the AP. A leveraged full duplex technology at the AP is detailed in FIGS. 2-6, enabling spatial multiple access by multiple devices in a random access wireless LAN network. Full duplex functionality is leveraged at the AP by an efficient uplink MU-MIMO MAC protocol that operates in a distributed and contention based manner. The full duplex AP announces its available remaining antenna capability as well as the channel information of a winning client while receiving a new uplink packet. Other client devices in the network may then measure their channel correlations with respect to the winning clients and contend for additional uplink streams if the correlation is less than a certain threshold. In particular, a new MAC protocol, Full Duplex-Multiple input Media Access Control (FD-MiMAC), enables concurrent transmissions by multiple client devices in a distributed and contention based manner.

FD-MiMAC, provides a novel mechanism for leveraging full duplex functionality at the AP to enable spatial multiple access in wireless LANs. FD-MiMAC only requires full duplex functionality at the AP, may be incrementally deployed along with current 802.11 AP and client devices, and may be easily implemented by client devices in a distributed and contention based manner using a novel scheme to pair users in uplink MU-MIMO to enhance system performance.

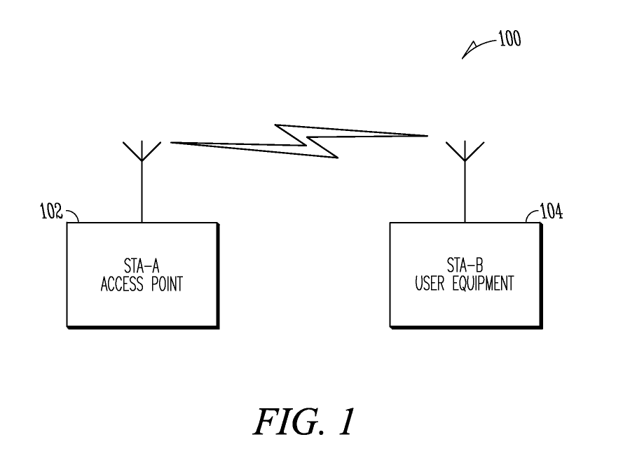

FIG. 1 illustrates various network elements of a wireless network in accordance with some embodiments. Wireless network 100 includes a plurality of communication stations (STAs) and one or more access points (APs) which may communicate in accordance with IEEE 802.11 communication techniques. The communication stations may be mobile devices that are non-stationary and do not have fixed locations. The one or more access points may be stationary and have fixed locations. The stations may include an AP STA-A 102 and one or more user equipment STA-B 104. The AP 102 may be a communication station that communicates with user equipment STA-B 104 using FD-MiMAC protocol. The AP STA-A may AP announce its available remaining antenna capability as well as the channel information of a winning client, as described in more detail below in FIGS. 2-6.

FIG. 2 compares exemplary conventional single user MIMO operations having low gain due to interference between clients to a FD-MiMAC full duplex operation 200. An exemplary Spatial Multiple Access (SAM) media access protocol enables uplink MU-MIMO operation in a distributed and contention based manner. However, this theoretical scheme only supports one uplink stream per user, cannot reliably detect the number of available remaining antenna capability due to false positives created by packet transmissions by neighboring APs and/or user equipments, and relies on MAC header decoding of the first uplink packet by other users, which may not be available in practice. Further, there is no mechanism for pairing appropriate users.

A conventional single user MIMO operation 204, comprises a half duplex AP 206 typical in many current WLAN MIMO implementations. AP 206 may generally communicate with one client device 208A-C at a time. Because a client user equipment typically has less antennas than an AP 206, MIMO gains are limited, as MIMO gain is proportional to the lesser of the number of antennas at the AP or client device. AP 206 can simultaneously transmit to and receive from different half duplex client user equipment 208A-C, However, gain is low due to uplink to downlink interference between clients 208A-C.

Another conventional full duplex communication operation 210 enables a wireless user equipment 212A to simultaneously send and receive on the same frequency band, potentially doubling the link capacity. However, the potential is unrealized in practice because full duplex communication provides marginal gains when applied to multi-user wireless LAN MIMO due to high levels of interference caused by uplink client(s) 212A on downlink client(s) 212B.

By comparison, an FD-MiMAC full duplex operation 212 leverages full duplex capability to communicate control information with AP 214 while receiving uplink packet(s) from device clients 216A-C, which facilitate and enable uplink access by multiple clients 216A-C. Rather than using full duplex to enable bi-directional MU-MIMO communication, the FD-MiMAC protocol operations performed by AP 214 utilize full duplex communication functionality at the AP to send small amounts of control information that enables efficient uplink MU-MIMO in a distributed and contention based manner. Using an FD-MiMAC uplink MU-MIMO protocol, all clients 216A-C may transmit simultaneously to make full use of the AP's 214 antennas. Thus, the network capacity increases linearly with the number of antennas at the AP 214, providing an advantageous capacity at the device in the network, i.e AP 214 that can best accommodate the cost, size, and power of a relatively large number of antennas.

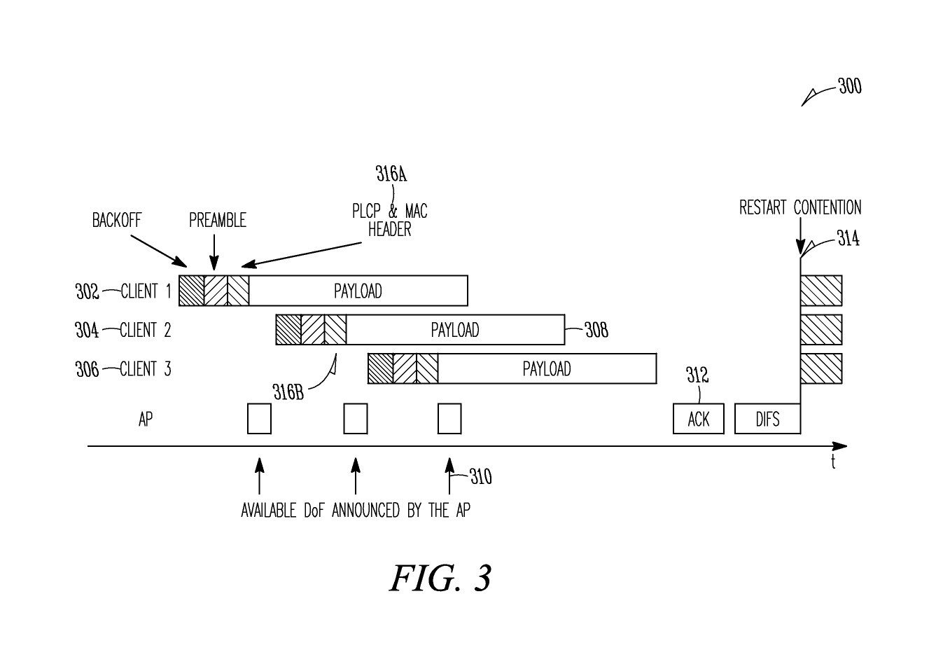

FIG. 3 illustrates an exemplary Spatial Multiple Access Uplink protocol for wireless LANs, leveraging distributed contentional full duplex functionality. The FD-MiMAC protocol overcomes the traditional limitations of polling and interference by explicitly announcing, at the AP, any of its remaining available remaining antenna capability, as well as the channel information of winning clients. Other clients with appropriate channel conditions may then contend for these remaining antenna capability (i.e. remaining antenna resources) in a distributed manner because the AP quickly identifies uplink packets addressed to itself for announcing the number of additional available uplink streams it can receive simultaneously. In order to avoid pairing of users with bad channel conditions other clients may decide to join the contention for additional uplink transmissions based on their channel correlation with the channels of existing winning clients.

FD-MiMAC is a contention based probabilistic MAC protocol in which a node verifies the absence of other traffic before transmitting on a shared transmission medium, such as a wireless LAN network. AP transmitter carrier sensing uses feedback from client user equipment receivers to determine whether another transmission is in progress before initiating a transmission. In other words, the AP detects the presence of a carrier wave from another device before attempting to transmit. If a carrier is sensed, the AP waits for the transmission in progress to finish before initiating its own transmission. In other words, FD-MiMAC is based on the principle “sense before transmit” or “listen before talk” because transmissions by one node are generally received by all other devices connected to the transmission medium.

FIG. 3 illustrates a FD-MiMAC protocol scenario in which three backlogged clients (Client 1 302, Client 2 304, Client 3 306) contend for a first transmission opportunity where the FD-MiMAC protocol uses IEEE 802.11 back-off procedures and contention window parameters. Client 1 302, winning the contention, immediately begins transmitting its frame 308, while other clients (304, 306) defer to its transmission. Once the AP 214 receives the header 316A of the packet and identifies itself as the intended receiver, the AP 214 immediately announces additional transmission opportunities (or remaining antenna capability 310) that are available for other backlogged clients (304, 306) to transmit to the same AP 214.

Backlogged clients (304, 306) randomly contend for the second transmission. As shown, winning Client 2 304, starts its transmission, and the AP 214 again declares the available transmission opportunities 310 for contention by other clients, unless the AP 214 announces that all remaining antenna capability, or Degrees of Freedom (DoF), 310 have been exhausted. If there are no more remaining DoFs 310, Client 2 304 and Client 3 306 should defer their transmission contention attempts until the channel resources become idle again. At the end of a transmission burst by a client (302-306), an Acknowledgement to All (ACK-to-all) frame 312 is transmitted by the AP 214 to acknowledge all received frames in the last transmission burst. Once the channel becomes idle again for a certain period of time, all clients may restart contention for transmission of next frames 314.

A collision may occur if two clients (302-306) attempt transmission in the same contention slot. All or some of the clients' packets may not be correctly decoded at the AP 214. Packet loss may also be caused by wireless channel errors. In order to handle user specific packet losses, the ACK-to-All frame may contain additional fields for each successfully received uplink frame. FD-MiMAC adopts a random binary exponential back-off mechanism in the event of collisions.

### Operation With Legacy Client and Access Point Devices

FD-MiMAC remains compatible in the presence of legacy devices. For example, if the AP is a legacy Carrier Sense Multiple Access (CSMA) client, available remaining antenna capability will not be announced to FD-MiMAC clients 302-306 such that FD-MiMAC clients 302-306 will avoid parallel uplink stream transmissions and behave as a normal CSMA client. In a legacy environment, both FD-MiMAC and CSMA clients contend for the first transmission opportunity using the standard mechanism as defined by the 802.11 MAC.

If an FD-MiMAC client wins the standard contention, then other FD-MiMAC clients may continue standard contention for additional transmission opportunities. All CSMA clients will hold their transmission attempts until the channel is idle again due to physical carrier sensing. If a CSMA client wins the standard contention, all clients including FD-MiMAC clients and other CSMA clients will defer their transmission so that they do not interfere with the anticipated subsequent ACK frame. Because an FD-MiMAC enabled AP 214 can distinguish between FD-MiMAC clients and legacy clients (for example, FD-MIMAC clients can announce their support during association), the AP 214 may announce the number of additional transmission opportunities as zero in order to deter FD-MiMAC clients 302-306 from further uplink transmissions.

### Distributed Pairing of Client Devices for Efficient Reception at the AP

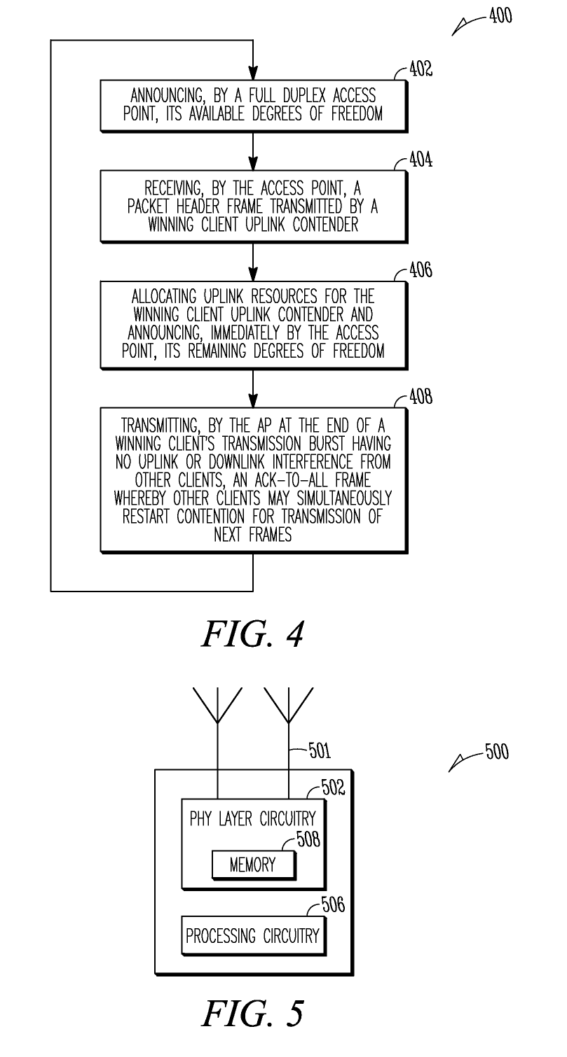

At the AP 214, zero forcing successive interference cancellation (ZF-SIC) or other techniques are applied to decode successively received symbols, enabling multiple FD-MiMAC clients 302-306 to simultaneously transmit to the AP 214. Success of the decoding process depends on the channel correlation of the transmitting clients 302-306 with respect to one another. Clients having insufficient channel correlation with respect to current contention winning clients are filtered in a distributed manner by efficiently pairing multiple users in every round of contention. Operation of FD-MiMAC is detailed below in FIG. 4

FIG. 4 is a high level overview flow chart illustrating operation of Spatial Multiple Access Uplink for Wireless LANs, according to some example embodiments. A round of contention for uplink resources by client user equipment begins in operation 402 when an AP announces its available remaining antenna capability by broadcasting the number of additional uplink streams it can support. The number of additional uplink stream resources the AP can support may be determined by its number of antennas, the channel information of its currently supported uplink streams, and other factors.

Channel information may comprise quantized channel information. For example a code book structure may be used to represent a quantized version of channel vector. Every competing client user equipment calculates the correlation of its channel with an already supported channel and will join the round of contention only if the correlation is less than a predetermined threshold, δ. Otherwise, client user equipment wait for the next round of contention. A client user equipment may use information announced by the AP to obtain an estimate of its channel with respect to the AP, or in another embodiment, use a history of past channel estimates. All contending client user equipment store the channel information of already supported client (s).

For example, Client 1 (FIG. 3, 302) may have an uplink channel already supported by the AP. When the AP announces its remaining antenna capability, Client 2 (FIG. 3, 304) may calculate the correlation of its channel with the uplink channel of Client 1 (FIG. 3, 302). At the i^{th} stage, every competing client user equipment calculates the correlation of its channel with the channels of all of the other client user equipment uplink channels being supported by the AP (which have been announced by the AP in previous iterations), and will join the contention only if the correlation is less than a defined threshold, δ. Control flow proceeds to operation 404.

In operation 404, the AP receives a packet header from a winning client contender. For example, the AP may receive a packet header (FIG. 3, 316B) from winning contender Client 2 (FIG. 3, 304). Control flow proceeds to operation 406.

In operation 406, immediately after receiving the packet header from a winning contender, the AP announces its remaining antenna capability, which are available after resources for supporting the uplink channel of the winning contender have been calculated. The winning contender may transmit and receive regular traffic without interference from other clients. Control flow proceeds to operation 408.

In operation 408, at the end of a winning client's transmission burst having no uplink or downlink interference from other clients, the AP broadcasts an h. Operations 402-408 are repeated until the AP announces that no additional uplink streams can be transmitted, either because all the available resources are exhausted or, aggregate throughput cannot be further increased by additional uplink clients.

FIG. 5 shows a functional diagram of an exemplary communication station in accordance with some embodiments. In one embodiment, FIG. 5 illustrates a functional block diagram of an AP 102 or client user equipment 104 in accordance with some embodiments. The communication station 500 may include physical layer circuitry 502 for transmitting and receiving signals to and from other communication stations using one or more antennas 501. The communication station 500 may also include medium access control layer (MAC) circuitry 504 for controlling access to the wireless medium. Communication Station 500 may also include processing circuitry 506 and memory 508 arranged to perform the operations described herein. In some embodiments, the physical layer circuitry 502 and the processing circuitry 504 may be configured to perform operations detailed in FIG. 4.

In accordance with some embodiments, the MAC circuitry 504 may be arranged to contend for a wireless medium, configure frames or packets for communicating over the wireless medium, and the PHY circuitry 502 may be arranged to transmit and receive signals. The PHY circuitry 502 may include circuitry for modulation/demodulation, upconversion/downconversion, filtering, amplification, etc. In some embodiments, the processing circuitry 504 of the communication station 500 may include one or more processors. In some embodiments, two or more antennas 501 may be coupled to the physical layer circuitry 502 arranged for sending and receiving signals. The memory 508 may store information for configuring the processing circuitry 506 to perform operations for configuring and transmitting message frames and performing the various operations described herein.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly.

In some embodiments, the communication station 500 may include one or more antennas 501. The antennas 501 may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated to take advantage of spatial diversity and the different channel characteristics that may result between each of antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although communication station 500 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory memory mechanism 508 for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station STA 400 may include one or more processors and may be configured with instructions stored on a computer-readable storage device memory 508.

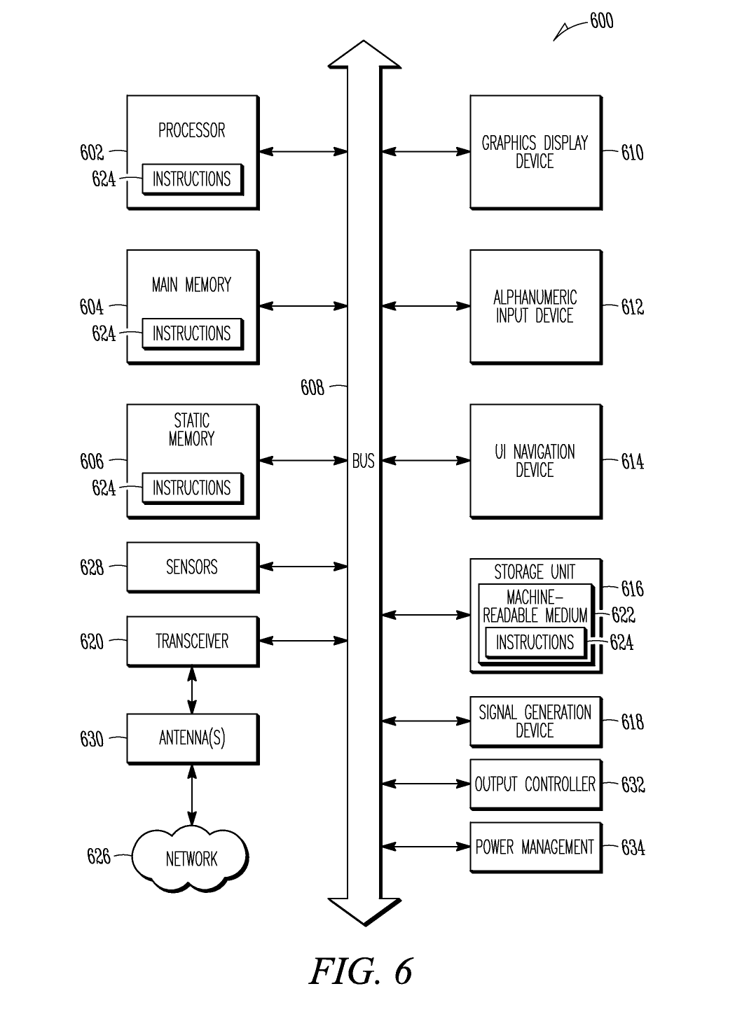

FIG. 6 illustrates a block diagram of another example machine 600 upon which any one or more of the techniques (e.g., methodologies) discussed herein may performed. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a graphics display unit 610, an alphanumeric input device 612 (e.g., a keyboard), and a user interface (UI) navigation device 614 (e.g., a mouse). In an example, the display unit 610, alphanumeric input device 612 and User Interface navigation device 614 may be a touch screen display. The machine 600 may additionally include a storage device (e.g., drive unit) 616, a signal generation device 618 (e.g., a speaker), a transceiver 620, and one or more sensors 628, such as a global positioning system (GPS) sensor, compass, accelerometer, or other sensor.

The storage unit device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage unit device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received by transceiver 620 over a communications network 626 using a transmission medium utilizing any one of a number of transfer protocols (e.g., frame relay, internet protocol (IP), transmission control protocol (TCP), user datagram protocol (UDP), hypertext transfer protocol (IITTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the transceiver 620 may include one or more physical jacks (e.g., Ethernet, coaxial, or phone jacks) or one or more antennas 630 to connect to the communications network 626. In an example, the transceiver 620 may include, or be coupled to, a plurality of antennas 630 to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

As used herein, a HetNet may be a cellular network system (e.g., 3GPP system) using multiple different cell types, such as macro, micro, femto, or pico cells. Some or all of the applied cell types may or may not be (partially or fully) overlapping in time, space, or frequency. A HetNet may also be a cellular network combined with other non-cellular technology networks such as WiFi (IEEE 802.11a/b/g/n/ac/ad), WiFi for TVWS (IEEE 802.11af), mmWave systems, or the like. Some or all of the coverage areas or cells of the technologies in the HetNet may or may not be (partially or fully) overlapping in time, space, or frequency.

Wired communications may include serial and parallel wired mediums, such as Ethernet, Universal Serial Bus (USB), Firewire, Digital Visual Interface (DVI), High-Definition Multimedia Interface (HDMI), etc. Wireless communications may include, for example, close-proximity wireless mediums (e.g., Radio Frequency (RF), such as based on the Near Field Communications (NFC) standard, InfraRed (IR), Optical Character Recognition (OCR), magnetic character sensing, or the like), short-range wireless mediums (e.g., Bluetooth, WLAN, Wi-Fi, etc.), long range wireless mediums (e.g., cellular wide area radio communication technology that may include, for example, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g., UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA UMTS (Wideband Code Division Multiple Access Universal Mobile Telecommunications System), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System—Time-Division Duplex), TD-CDMA (Time Division—Code Division Multiple Access), TD-CDMA (Time Division—Synchronous Code Division Multiple Access), 3GPP Rd. 8 (Pre-4G) (3rd Generation Partnership Project Release 8 (Pre-4th Generation)), 3GPP Rd. 9 (3rd Generation Partnership Project Release 9), 3GPP Rd. 10 (3rd Generation Partnership Project Release 10) , 3GPP Rd. 11 (3rd Generation Partnership Project Release 11), 3GPP Rd. 12 (3rd Generation Partnership Project Release 12), 3GPP Rel. 13 (3rd Generation Partnership Project Release 13) and subsequent Releases (such as Rel. 14, Rel. 15, etc.), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideb and Integrated Digital Enhanced Network), iBurst, Unlicensed Mobile Access (UMA, also referred to as also referred to as 3GPP Generic Access Network, or GAN standard), electronic interaction via sound waves, IEEE 802.11a/b/g/n/ac/ad/af, WiFi, WiFi for TVWS, IEEE 802.16e/m, WiMAX, or the like.

In one embodiment, an Access Point (AP) in a wireless local area network comprises processor(s) configured to announce its available remaining antenna capability, receive, a packet header frame transmitted by a winning client uplink contender, allocate uplink resources for the winning client uplink contender and immediately announce its remaining antenna capability, and transmit, at the end of a winning client's transmission burst, an Acknowledge-to-All frame, whereby other clients may simultaneously restart contention for transmission of next frames.

In another embodiment, A method for spatial multiple access uplink in a wireless local area network comprises announcing, by an Access Point (AP), its available remaining antenna capability, receiving, by the AP, a packet header frame transmitted by a winning client uplink contender, allocating, by the AP, uplink resources for the winning client uplink contender and immediately announcing its remaining antenna capability; and transmitting, by the AP, at the end of a winning client's transmission burst, an Acknowledge-to-All frame, whereby other clients may simultaneously restart contention for transmission of next frames.

In another embodiment, a User Equipment (UE) comprises a transceiver configured to receive, from an Access Point (AP), an announcement of its available remaining antenna capability, calculate a correlation of it channel with a channel of a winning uplink client, and transmit a packet header frame to contend for an uplink channel from the AP.

In another embodiment, A non-transitory computer readable storage device includes instructions stored thereon, the instructions, which when executed by a machine, cause the machine to perform operations comprising announcing, by an Access Point (AP), its available remaining antenna capability, receiving, by the AP, a packet header frame transmitted by a winning client uplink contender, allocating, by the AP, uplink resources for the winning client uplink contender and immediately announcing its remaining antenna capability, and transmitting, by the AP, channel information of the winning client uplink contender.

### Additional Notes

The above Description of Embodiments includes references to the accompanying drawings, which form a part of the detailed description. The drawings show, by way of illustration, specific embodiments in which methods, apparatuses, and systems discussed herein may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

The flowchart and block diagrams in the FIGS. 1-4 illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The functions or techniques described herein may be implemented in software or a combination of software and human implemented procedures. The software may consist of computer executable instructions stored on computer readable media such as memory or other type of storage devices. The term “computer readable media” is also used to represent any means by which the computer readable instructions may be received by the computer, such as by different forms of wired or wireless transmissions. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

As used herein, a “-” (dash) used when referring to a reference number means “or”, in the non-exclusive sense discussed in the previous paragraph, of all elements within the range indicated by the dash. For example, 103A-B means a nonexclusive “or” of the elements in the range {103A, 103B}, such that 103A-103B includes “103A but not 103B”, “103B but not 103A”, and “103A and 103B”.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Description of Embodiments, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Description of Embodiments as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

1-25. (canceled)

26. An apparatus of an Access Point (AP) configured to operate in a wireless local area network, the apparatus comprising: processing circuitry; and, memory coupled to the processing circuitry, the processing circuitry configured to:
configure the AP to announce its available remaining antenna capability;
decode a packet header frame transmitted by a winning station uplink contender;
allocate uplink resources for the winning station uplink contender and configure the AP to immediately announce its remaining antenna capability; and
configure the AP to transmit, at the end of a winning station's transmission burst, an Acknowledge-to-All frame, wherein other stations simultaneously restart contention for transmission of next frames.

27. The apparatus of claim 26, wherein the processing circuitry is further configured to configure the AP to announce its available remaining antenna capability by broadcasting a number of additional uplink streams that the AP can support.

28. The apparatus of claim 26, wherein the processing circuitry is further configured to determine a number of additional uplink stream resources the AP can support according to the AP's number of antennas.

29. The apparatus of claim 26, wherein the processing circuitry is further configured to determine a number of additional uplink stream resources that the AP can support according to channel information of currently supported uplink streams.

30. The apparatus of claim 26, wherein the processing circuitry is further configured to transmit channel information of a winning station uplink contender.

31. The apparatus of claim 26, wherein the access point, the winning station uplink contender, and other stations are each one from the following group: an Institute of Electrical and Electronic Engineers (IEEE) 802.11 access point or an IEEE 802.11 station.

32. The apparatus of claim 26, further comprising transceiver circuitry coupled to the processing circuitry; and, one or more antennas coupled to the transceiver circuitry.

33. A method performed by an apparatus of an access point (A) for spatial multiple access uplink in a wireless local area network, the method comprising:
configuring the AP to announce its available remaining antenna capability;
decoding a packet header frame transmitted by a winning station uplink contender;
allocating uplink resources for the winning station uplink contender and configure the AP to immediately announce its remaining antenna capability; and
configuring the AP to transmit, at the end of a winning station's transmission burst, an Acknowledge-to-All frame, wherein other stations simultaneously restart contention for transmission of next frames.

34. The method of claim 33, the method further comprising:
configuring the AP to announce the AP's available remaining antenna capability by broadcasting a number of additional uplink streams that the AP can support.

35. The method of claim 33, the method further comprising:
determining a number of additional uplink stream resources the AP can support according to the AP's number of antennas.

36. An apparatus of a station (STA) comprising: a memory; and processing circuitry couple to the memory, wherein the processing circuitry is configured to:
decode, from an Access Point (AP), an announcement of the AP' s available remaining antenna capability;
determine a correlation of a channel of the STA with a channel of a winning uplink client; and
configure the STA to transmit a packet header frame to contend for an uplink channel from the AP.

37. The apparatus of claim 36, wherein the processing circuitry is further configured to:
configure the STA to join contention for an uplink channel when the determined correlation of the channel of the STA is less than a defined threshold.

38. The apparatus of claim 36, wherein the processing circuitry is further configured to:
determine an estimate of the channels of the STA with respect to the AP based on information announced by the AP; and
determine the correlation further based on the estimate of the channels of the STA.

39. The apparatus of claim 36, wherein the processing circuitry is further configured to:
store channel information of other STAs already having an uplink channel supported by an AP.

40. The apparatus of claim 36, wherein the processing circuitry is further configured to:
restart contention for transmission of next frames when the STA receives an ACK-to-All frame from the AP.

41. The apparatus of claim 36, further comprising transceiver circuitry coupled to the processing circuitry; and, one or more antennas coupled to the transceiver circuitry.

42. A non-transitory computer-readable storage medium that stores instructions for execution by one or more processors, the instructions to configure the one or more processors to cause an apparatus of an access point to:
configure the AP to announce its available remaining antenna capability;
decode a packet header frame transmitted by a winning station uplink contender;
allocate uplink resources for the winning station uplink contender and configure the AP to immediately announce its remaining antenna capability; and
configure the AP to transmit, at the end of a winning station's transmission burst, an Acknowledge-to-All frame, wherein other stations simultaneously restart contention for transmission of next frames.

43. The non-transitory computer readable storage device of claim 42, wherein the instructions further configure the one or more processors to cause the apparatus to:
configure the AP to announce the AP's available remaining antenna capability by broadcasting a number of additional uplink streams that the AP can support.

44. The non-transitory computer readable storage device of claim 42, wherein the instructions further configure the one or more processors to cause the apparatus to:
determine a number of additional uplink stream resources the AP can support according to the AP's number of antennas.

45. The non-transitory computer readable storage device of claim 42, wherein the instructions further configure the one or more processors to cause the apparatus to:
determine a number of additional uplink stream resources the AP can support according to channel information of currently supported uplink streams.
